(19) United States
(12) Patent Application Publication
(10) Pub. No.: US 2015/0170517 A1
(43) Pub. Date: Jun. 18, 2015

(54) VEHICLE PARKING MANAGEMENT SYSTEM WITH GUIDANCE FOR INDICATING FLOOR VACANT VEHICULAR PARKING DOCK

(71) Applicant: Chen YAN, Kaohsiung City (TW)

(72) Inventor: Chen YAN, Kaohsiung City (TW)

(21) Appl. No.: 14/558,825

(22) Filed: Dec. 3, 2014

Related U.S. Application Data
(60) Provisional application No. 61/915,032, filed on Dec. 12, 2013.

(51) Int. Cl. G08G 1/14

(52) U.S. Cl. CPC G08G 1/141

(57) ABSTRACT

A vehicle parking management system with guidance for indicating floor vacant vehicular parking dock comprises a plurality of detectors, a plurality of display units, a servo and a power supply. Each detector includes an optical sensor securely fixed in each corresponding vehicle parking dock. Each display unit includes an illuminator securely fixed in front margin of each corresponding vehicle parking dock. The servo, which respectively connects to an entrance ticket machine of the parking lot, each detector and each display unit of every vehicle parking dock via a connected cabled network, includes a controlling program functioning to create a chasing lights display of Marquee sign. By means of the chasing lights display, every driver can quickly find vacant parking dock in the parking lot without any difficulty so that no vehicle congestion or long vehicle queue will happen.

This application claims the benefit of provisional U.S. Patent Application No. 61/915,032, filed Dec. 12, 2013, and incorporated herein by reference.

### FIELD OF THE PRESENT INVENTION

The present invention of a vehicle parking management system with guidance for indicating floor vacant vehicular parking dock belongs to a technical field of vehicle parking guidance system, particularly for one that it has a detector and a display unit securely fixed in front margin of each corresponding vehicle parking dock as well as a servo functioning to create a chasing lights display of Marquee sign. By means of the chasing lights display, every driver can quickly spot vacant parking dock in the parking lot without any difficulty or time-wasting depression.

### BACKGROUND OF THE INVENTION

Currently, vehicle parking subject is a critical issue, to which every metropolis has to face. To solve this issue, the related government not only enthusiastically builds a lot of public vehicle parking lots or public vehicle parking towers but also encourages private businesses to set up private vehicle parking lots. For saving labor cost in running vehicle parking lot, most vehicle parking lots adopt unman management way as that shown in FIG. 1. A typical unman parking lot 10 comprises an exit charge controller 13 and an entrance ticket machine 12, which includes a start button 121, a parking ticket dispensing slot 122 and a boom barrier 123. The exit charge controller 13 and entrance ticket machine 12 are installed in different locations for large scale parking lot while the exit charge controller 13 and entrance ticket machine 12 are installed in adjacent manner of same location as shown in FIG. 1. Usually, upon the start button 121 on the entrance ticket machine 12 of the parking lot 10 being pressed by the vehicle C driver of the parking intention, the parking ticket dispensing slot 122 on the entrance ticket machine 12 immediately delivers a parking ticket or IC chip parking card for initiating parking charge calculation. Once the driver of the vehicle C take the parking ticket or IC chip parking card, the boom barrier 123 is opened to allow the vehicle C get into the parking lot 10 for parking in a vehicle parking dock 11 if it happens to be available.

However, some basement vehicle parking lots in buildings or department stores display a parking status showing whether the parking space is full or how many vacancies are still available by counter but do not indicate exact parking position available (as parking position 11A shown in FIG. 1). Accordingly, many vehicles have to look for vacant parking position floor by floor so that not only vehicle congestion is caused but also air pollution is incurred by extra consumed gasoline other than the time of the drivers is wasted. Especially for large vehicle parking lots affiliated by the airports or train stations, the difficulty in looking for a vacant parking position becomes worse. Frequently, some passengers will miss the expecting scheduled flight or train due to wasting time in vehicle parking. For better running the affiliated vehicle parking lots to keep the passengers, the airports or train stations have to hire more people to direct these parking vehicles to solve foregoing parking issue so that the running cost is increased due to higher labor cost. Alternatively, a screen showing all vacant parking positions is put at the entrance of the parking lot such as utility model Patent Numbers M374121 and M429953 of R.O.C. as well as utility model Patent Number CN2503548. As shown in FIG. 1, the common configuration of these patents aforesaid is that displaying all vacant parking positions 11As of the parking lot 10 on the a screen T let vehicle drivers check where the vacant parking positions 11As are. Normally, every driver will temporarily stop a while to see the screen T while some slow strangers may take more time to carefully surf the screen T so that a long queue of vehicles waiting for parking will created at the entrance of the parking lot 10 contrarily. Moreover, for some strange parking lots, most vehicle drivers are unfamiliar with the floor layout and planned vehicular circulating route of the parking lot, without rest effective assistance of guidance mechanism, they have to take more time to adapt themselves to slowly follow the planned vehicular circulating route of the parking lot to find expected parking position. Therefore, the conventional methods of these vehicle parking patents aforesaid can not overcome the drawback of quick finding the right vacant parking position in a parking lot.

### SUMMARY OF THE INVENTION

The primary object of the present invention is to provide a vehicle parking management system with guidance for indicating floor vacant vehicular parking dock, which comprises a plurality of detectors, a plurality of display units, a servo and a power supply. Each said detector includes an optical sensor for functioning to constantly monitor the parking status of its corresponding vehicle parking dock. Each said display unit includes a monochromatic illuminator for responding to immediately change the on/off lighting to reflect the parking status of its corresponding vehicle parking dock. The servo includes a controlling program for serving to receive, process, store and update all signals of parking status from detector, then transmit suitable command to each display unit of every vehicle parking dock. A sequence the lighting on/off order as a chasing lights display of Marquee sign is created so that any vehicle driver can easily follows the planned vehicular circulating route of the parking lot sequential blinks by the chasing lights display of Marquee sign to find the vacant parking dock in the parking lot.

The other object of the present invention is to provide a vehicle parking management system with guidance for indicating floor vacant vehicular parking dock, which includes a controlling program in a servo to create a sequence the lighting on/off order as a chasing lights display of Marquee sign. By means of the chasing lights display, every driver can quickly find vacant parking dock in the parking lot without any difficulty or time-wasting depression so that no vehicle congestion or long vehicle queue will happen.

### BRIEF DESCRIPTION OF THE DRAWINGS

FIG. 1 is a perspective schematic view for a typical floor of conventional vehicle parking lot.

FIG. 2 is a perspective schematic view showing the present invention installed in a typical floor of conventional vehicle parking lot.

FIG. 3 is a cross sectional view taken against the section line of 3-3 from previous

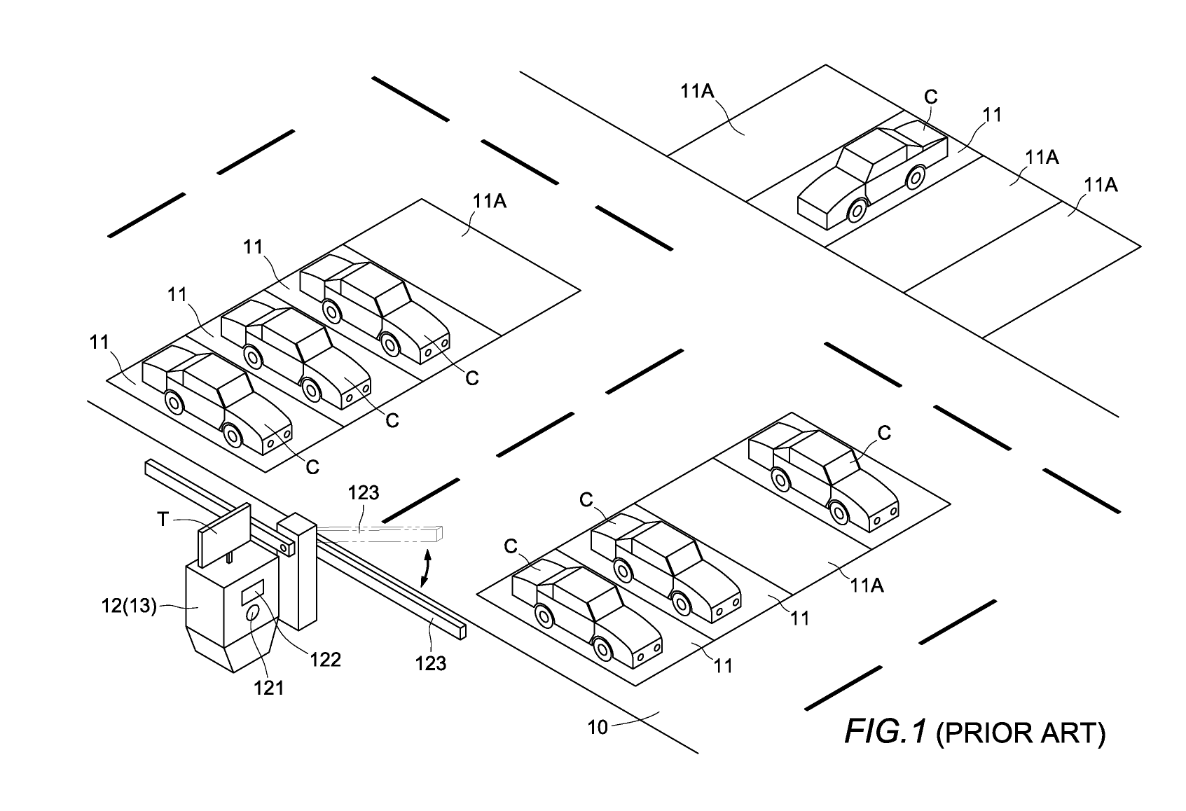

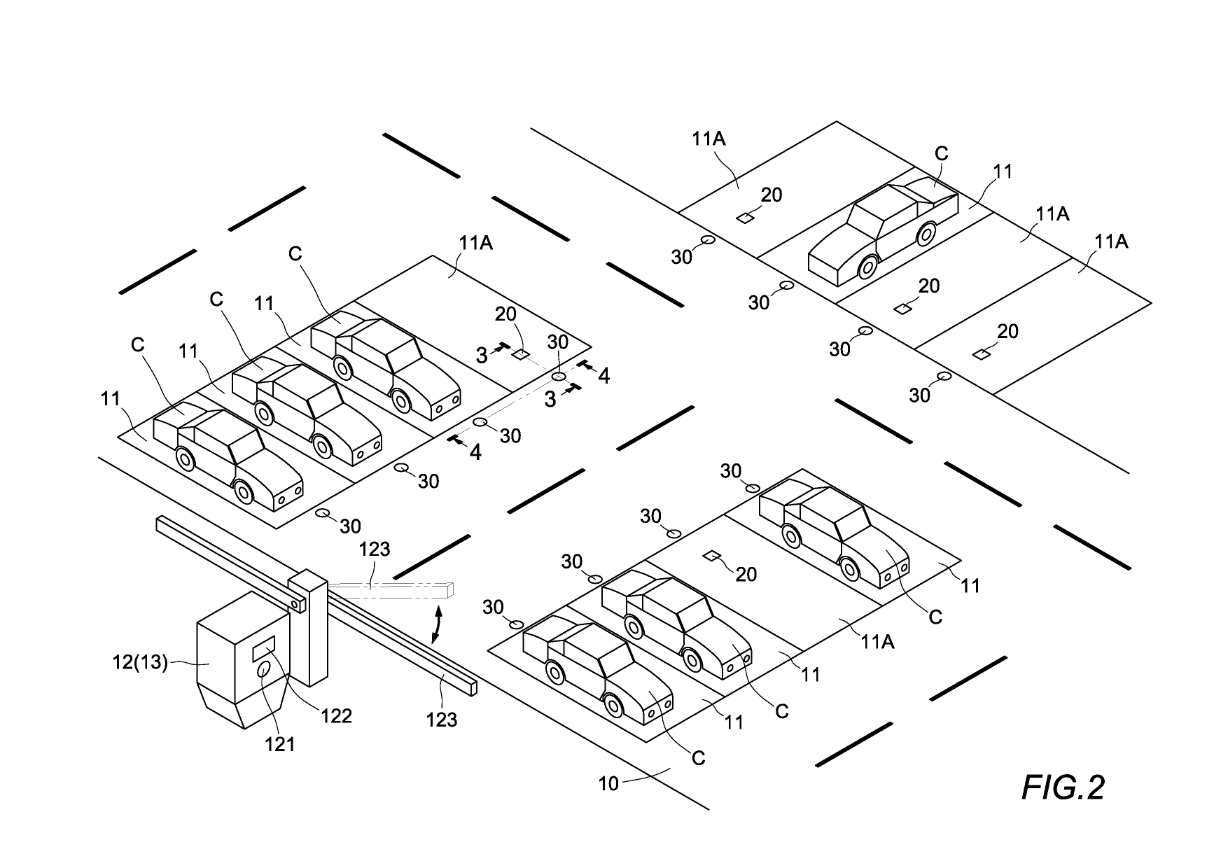

FIG. 2, wherein single illuminator is contained in a display unit.

FIG. 4 is a cross sectional view taken against the section line of 4-4 from previous

FIG. 2.

FIG. 5 is a floor block diagram showing the present invention installed in a typical floor of conventional vehicle parking lot.

FIG. 6 is a floor layout showing the first dynamic shifting sequence in chasing light display of Marquee sign for the present invention installed in a typical floor of conventional vehicle parking lot.

FIG. 7 is a floor layout showing the second dynamic shifting sequence in chasing light display of Marquee sign for the present invention installed in a typical floor of conventional vehicle parking lot.

FIG. 8 is the guidance mode 1 processed by the controlling program in servo of the present invention.

FIG. 9 is the guidance mode 2 processed by the controlling program in servo of the present invention.

FIG. 10 is another cross sectional view taken against the section line of 3-3 from previous FIG. 2, wherein dual illuminators are contained in a display unit.

FIG. 11 is the guidance mode 3 processed by the controlling program in servo of the present invention.

### DETAILED DESCRIPTION OF THE PREFERRED EMBODIMENTS

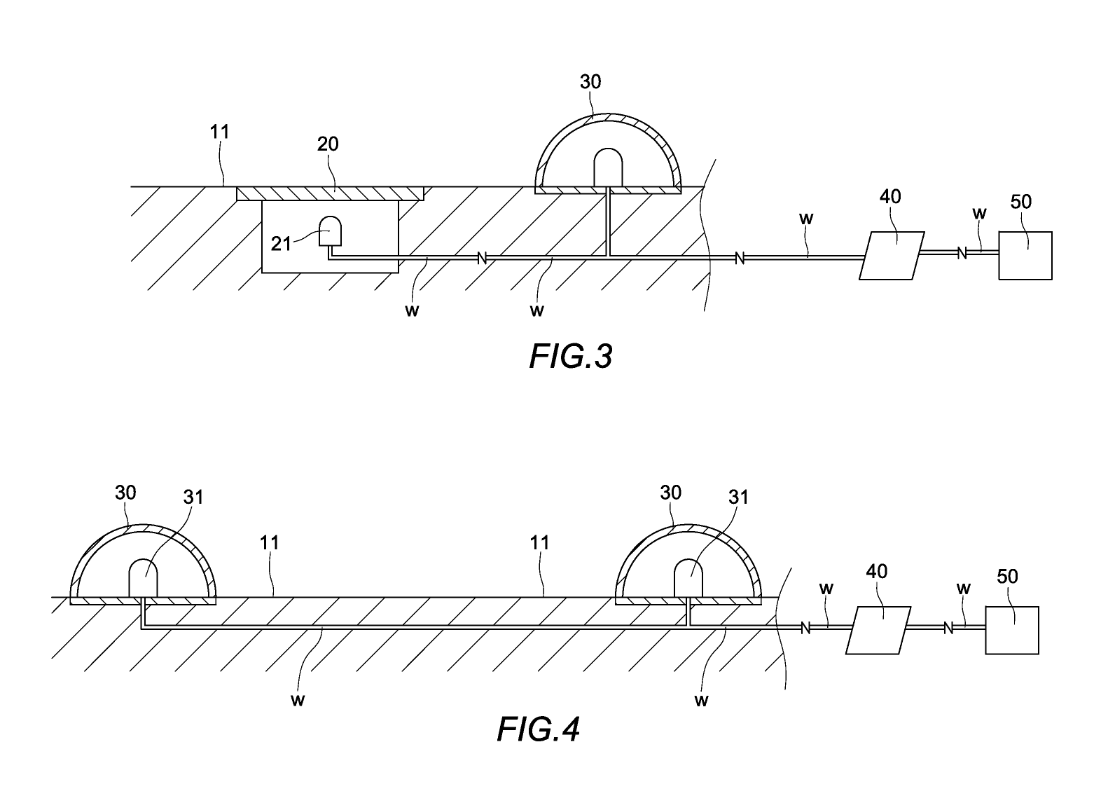

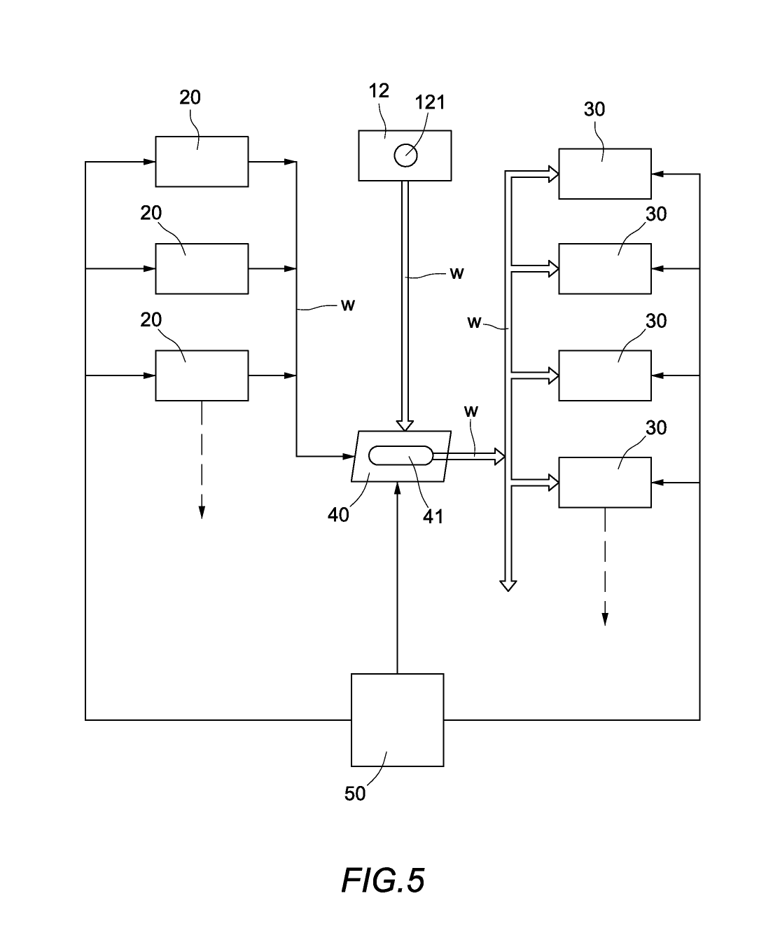

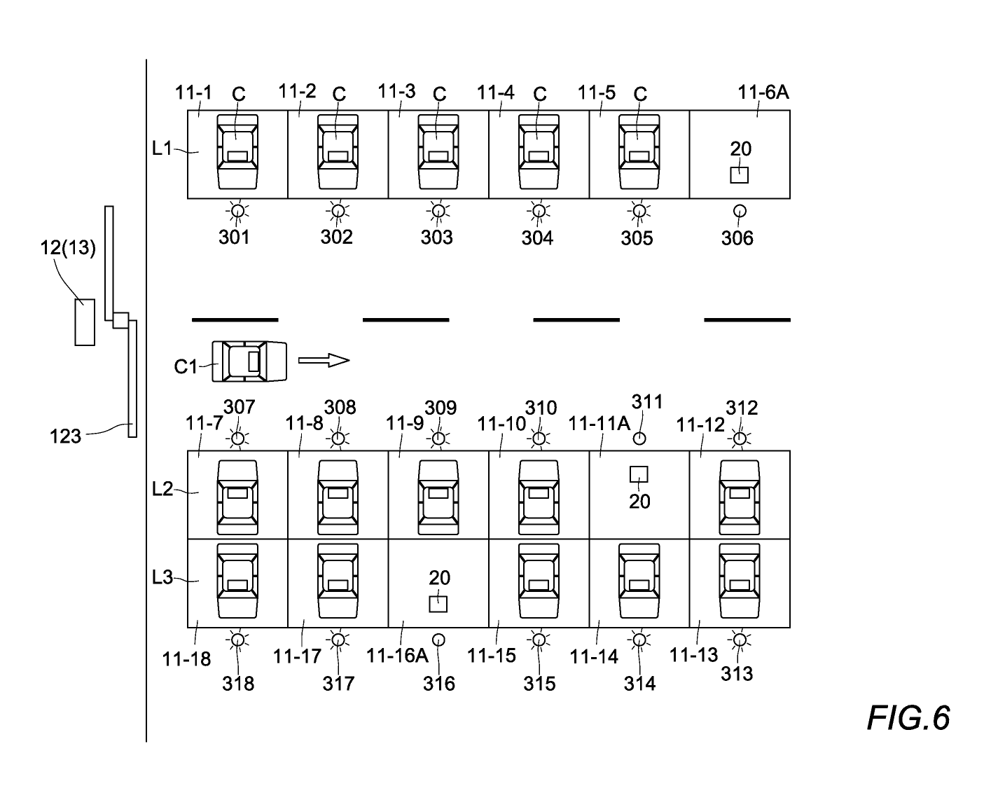

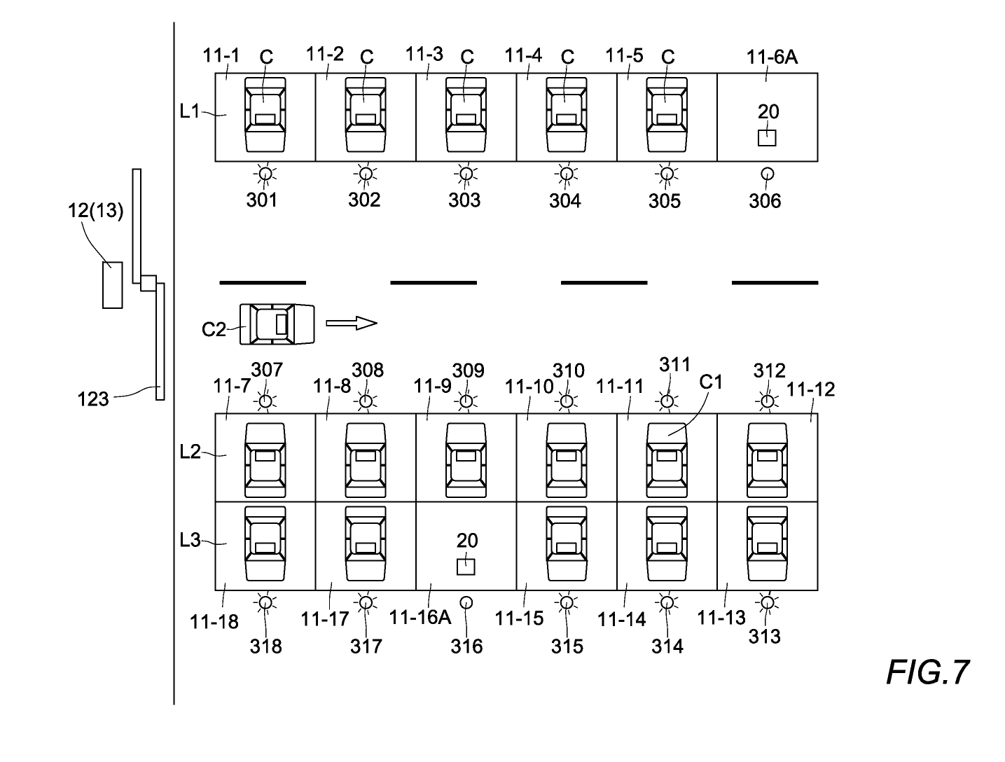

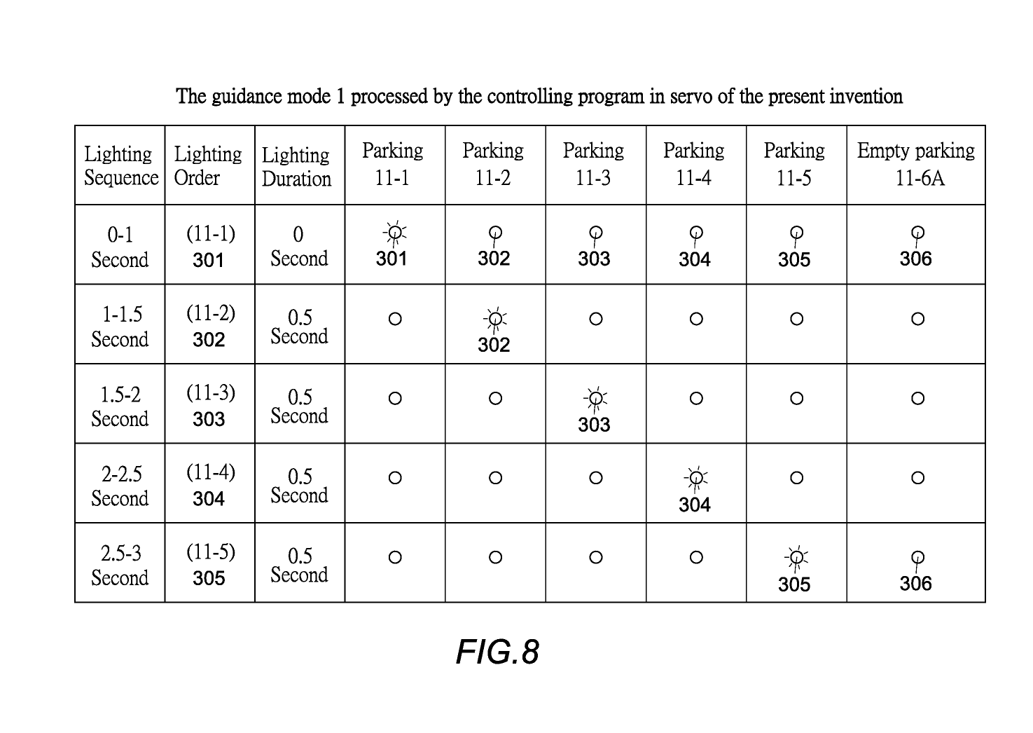

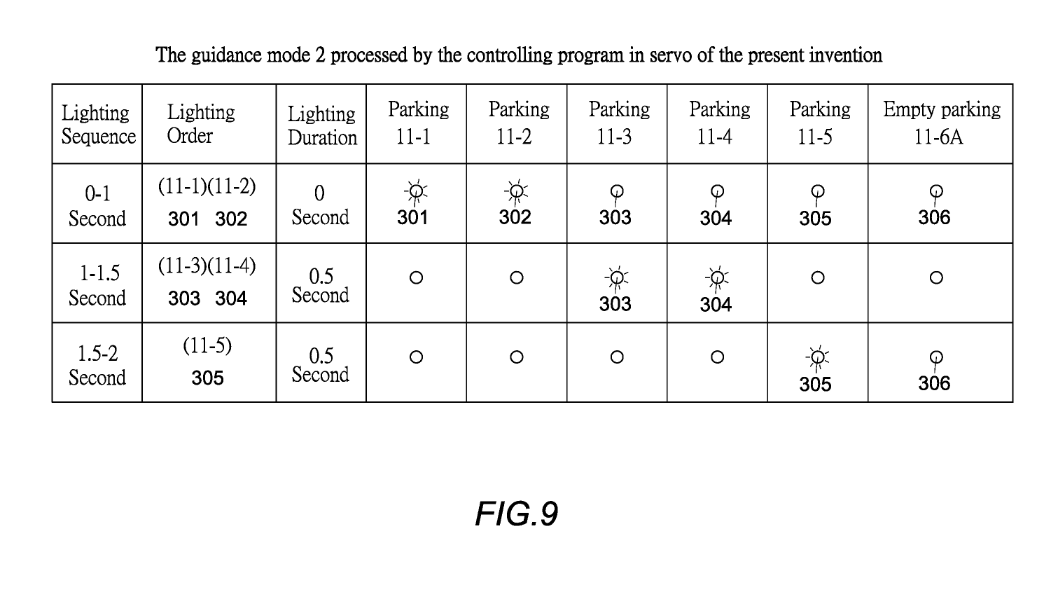

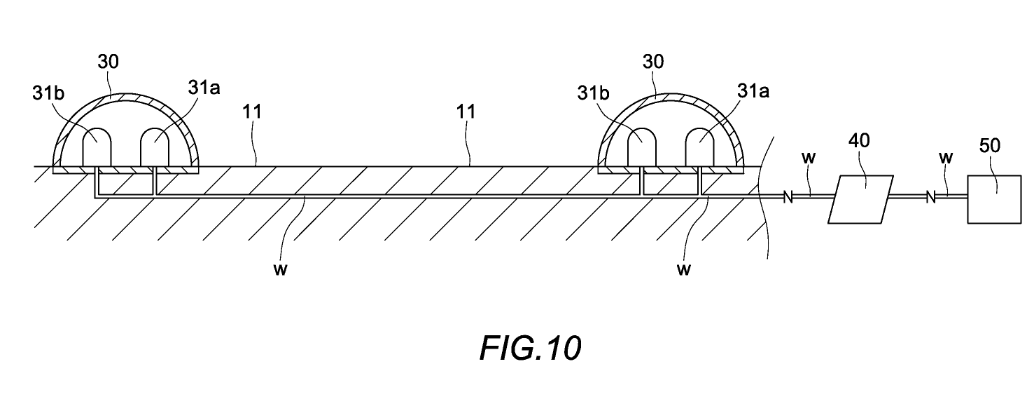

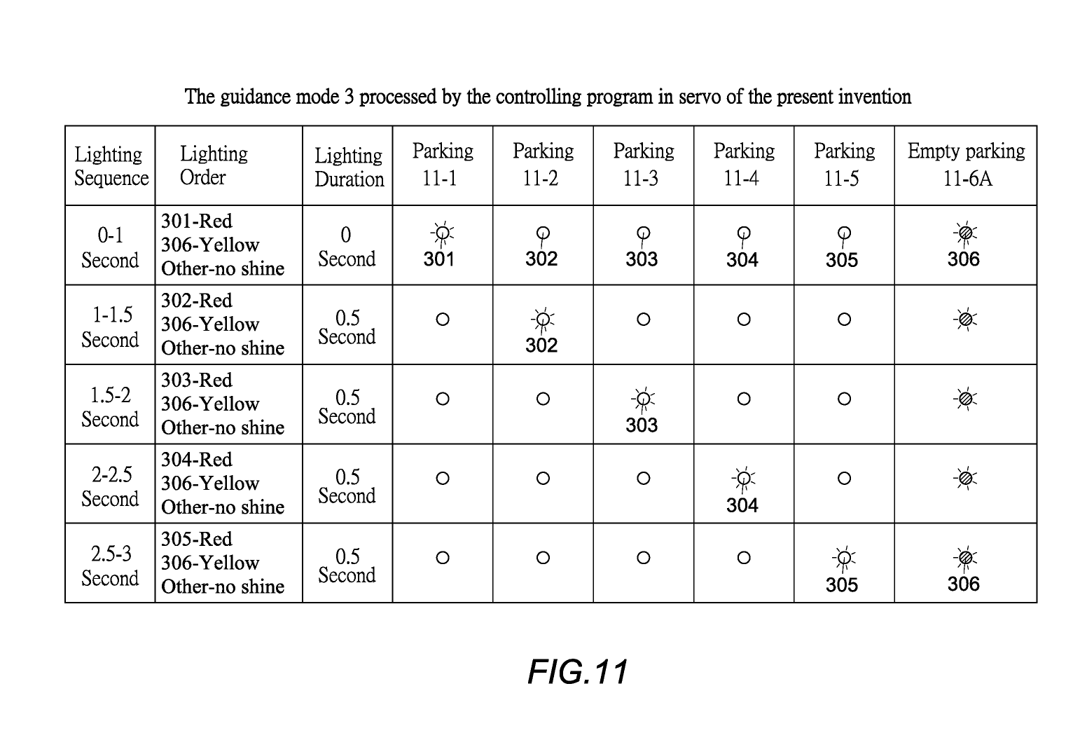

As shown of FIGS. 2 to 5, which show a preferred exemplary embodiment of the present invention installed in a typical floor of conventional vehicle parking lot. A “vehicle parking management system with guidance for indicating floor vacant vehicular parking dock” of the present invention comprises a plurality of detectors 20, a plurality of display units 30, a servo 40 and a power supply 50, wherein each said detector 20, which is securely fixed in each corresponding vehicle parking dock 11 of parking position, includes an optical sensor 21 for functioning to constantly monitor the parking status of its corresponding vehicle parking dock 11 and immediately relaying a signal of such parking status to the servo 40 via a connected cabled network W; each said display unit 20, which is securely fixed in front margin of each corresponding vehicle parking dock 11, includes a monochromatic illuminator 31 or two illuminators 31 of different colors for responding to immediately change the on/off lighting to reflect the parking status of its corresponding vehicle parking dock 11 and sequencing the lighting on/off order as a chasing lights display of Marquee sign in accordance with the command from the servo 40 via a connected cabled network W; said servo 40, which respectively connects to an entrance ticket machine 12 of the parking lot 10, each detector 20 and each display unit 30 of every vehicle parking dock 11 via a connected cabled network W, includes a controlling program 41 for serving to receive, process, store and update all signals of such parking status from detector 20, then transmit suitable command to each display unit 30 of every vehicle parking dock 11 if any incoming vehicle driver presses the start button 121 on the entrance ticket machine 12 so that each display unit 30 of every vehicle parking dock 11 starts to sequence the lighting on/off order as a chasing lights display of Marquee sign accordingly while the vehicle driver easily follows the planned vehicular circulating route of the parking lot 10 sequential blinks by the chasing lights display of Marquee sign to quickly find the vacant parking dock 11A in the parking lot 10; and said power supply 50, which includes an uninterruptible power supply (UPS), provides electrical energy to the detectors 20, display units 30 and servo 40.

Wherein, the optical sensor 21 of the detector 20 is made of anyone of the industrial electronic components such as thermoelectric infrared sensor, quantum infrared sensor, reflection-type active infrared transponder composing of an infrared LED and an infrared receiver, shading-type active infrared sensor composing of an infrared LED and an infrared receiver, as well as passive infrared sensor (PIR). By means of the optical sensor 21, it will immediately generate a signal of “occupied parking dock” if sensing a vehicle having parked in the vehicle parking dock 11 and while it will immediately generate a signal of “vacant parking dock” if sensing no vehicle having parked in the vehicle parking dock 11, then simultaneously transmit the signal to the servo 40 for processing, updating and storage. For example, suppose the optical sensor 21 is the shading-type active infrared sensor composing of an infrared LED and an infrared receiver, it will immediately generate high voltage as a signal of “occupied parking dock” if sensing a vehicle having parked in the vehicle parking dock 11 and while it will immediately generate low voltage as a signal of “vacant parking dock” if sensing no vehicle having parked in the vehicle parking dock 11.

Moreover, the display unit 30 includes one illuminator 31 or two illuminators 31 of different lighting colors chosen from anyone or dual-combination of following illuminators such as incandescent lamps or LEDs of various colors like red, blue, green, yellow, white and so on.

Please refer to FIGS. 5 and 6. FIG. 5 is a floor block diagram showing the present invention installed in a typical floor of conventional vehicle parking lot while FIG. 6 is a floor layout showing the first dynamic shifting sequence in chasing light display of Marquee sign for the present invention installed in a typical floor of conventional vehicle parking lot. Upon the start button 121 on the entrance ticket machine 12 of the parking lot being pressed by the vehicle C1 driver of the parking intention, the boom barrier 123 is opened to allow the vehicle C1 get into the parking lot for parking, meanwhile the controlling program 41 in the servo 40 is initiated to transmit suitable command to each display unit 30 of every vehicle parking dock 11 for starting to sequence the lighting on/off order as a chasing lights display of Marquee sign accordingly. Let the floor layout of parking status is assumed as below: for the first line of vehicle parking dock L1, vehicle parking docks 11-1, 11-2, 11-3, 11-4 and 11-5 are occupied while vehicle parking dock 11-6A is vacant; for the second line of vehicle parking dock L2, vehicle parking docks 11-7, 11-8, 11-9, 11-10 and 11-12 are occupied while vehicle parking dock 11-11A is vacant; and for the third line of vehicle parking dock L3, vehicle parking docks 11-13, 11-14, 11-15, 11-17 and 11-18 are occupied while vehicle parking dock 11-16A is vacant, wherein each display unit 30 is respectively labeled as 301 through 318 for each corresponding vehicle parking dock 11-1 through 11-18 individually. With this floor layout of parking status, a chasing lights display of Marquee sign is initiated as shown in attached table of “the guidance mode 1” in accordance with FIG. 6 so that the vehicle driver C1 can easily follow the planned vehicular circulating route of the parking lot sequential blinks by the chasing lights display of Marquee sign to quickly find the vacant parking dock 11-6A in the first line of vehicle parking dock L1, or the optional vacant parking dock 11-11A in the second line of vehicle parking dock L2 similarly. Therefore, by means of the “guidance mode 1” with a chasing lights display of Marquee sign in the present invention, the vehicle driver C1 can easily and quickly find vacant parking dock without any difficulty.

Incidentally, the driver C1 parks his/her vehicle in the vacant parking dock 11-11A in the second line of vehicle parking dock L2.

Please refer to FIGS. 5 and 7. FIG. 5 is a floor block diagram showing the present invention installed in a typical floor of conventional vehicle parking lot while FIG. 7 is a floor layout showing the second dynamic shifting sequence in chasing light display of Marquee sign for the present invention installed in a typical floor of conventional vehicle parking lot. Suppose a second vehicle C2 driver presses the start button 121 on the entrance ticket machine 12 of the parking lot, the boom bather 123 is also opened to allow the vehicle C2 get into the parking lot for parking, likewise the controlling program 41 in the servo 40 is initiated to transmit suitable command to each display unit 30 of every vehicle parking dock 11 for starting to sequence the lighting on/off order as a chasing lights display of Marquee sign accordingly (as shown in FIG. 5). With condition of parking dock 11-11A in the second line of vehicle parking dock L2 having been occupied by the parked vehicle of C1, the second vehicle driver C2 can easily follow the planned vehicular circulating route of the parking lot sequential blinks by the chasing lights display of Marquee sign to quickly find the vacant parking dock 11-6A in the first line of vehicle parking dock L1 (as shown in FIG. 6). Thus, by means of the “guidance mode 1” with a chasing lights display of Marquee sign in the present invention, the second vehicle driver C2 can easily and quickly find vacant parking dock without any difficulty too. Even driver C1 or C2 inadvertently miss to park vehicle in vacant parking docks 11-6A and 11-11A, he/she still can easily follow the planned vehicular circulating route of the parking lot sequential blinks by the chasing lights display of Marquee sign to quickly find the vacant parking dock 11-16A in the third line of vehicle parking dock L3 (as shown in FIG. 5). Therefore, by means of the present invention, even many vehicles get to the parking lot 10 in short time, every driver can quickly find vacant parking dock without any difficulty so that no vehicle congestion or long vehicle queue will happen.

As described above, the “the guidance mode 1” with a chasing lights display of Marquee sign in the present invention is set by the controlling program 41 in the servo 40. Still, there are many guidance modes can be arbitrarily created at the discretion of the manager of the parking lot. In this preferred exemplary embodiment of the present invention, three typical guidance modes are tabulated as clues for example. In the mode 1 processed by the controlling program 41 in the servo 40 of the present invention as shown in FIG. 8, the lighting sequence of chasing light display is set that sequencing the lighting on/off order is one illuminator for each time duration in accordance with the parking status in the floor layout of the FIG. 6, wherein the illuminator blinking “On/Off” denotes to that the corresponding parking dock is occupied while the illuminator keeping “Off” denotes to that the corresponding parking dock is vacant while in the guidance mode 2 processed by the controlling program 41 in the servo 40 of the present invention as shown in FIG. 9, the lighting sequence of chasing light display is set that sequencing the lighting on/off order is two adjacent illuminators for each time duration in accordance with the parking status in the floor layout of the FIG. 6, wherein the illuminator blinking “On/Off” denotes to that the corresponding parking dock is occupied while the illuminator keeping “Off” denotes to that the corresponding parking dock is vacant. In the guidance mode 3 processed by the controlling program 41 in the servo 40 of the present invention as shown in FIG. 10, the lighting sequence of chasing light display is set that sequencing the lighting on/off order is two illuminators in different parking docks for each time duration in accordance with the parking status in the floor layout of the FIG. 6, wherein the red illuminator blinking “On/Off” denotes to that the corresponding parking dock is occupied while yellow illuminator keeping “On” denotes to that the corresponding parking dock is vacant. With foregoing three exemplary guidance mode illustrated above, it is apparent that the present invention can be versatilely adapted to create other guidance modes at the discretion of the user.

In conclusion foregoing disclosure heretofore, by means of a preset the guidance mode with a chasing lights display of Marquee sign created by the servo in the present invention, any vehicle driver can easily follow the planned vehicular circulating route of the parking lot sequential blinks by the chasing lights display of Marquee sign to quickly find the vacant parking dock in the parking lot without any difficulty so that no vehicle congestion or long vehicle queue will happen. Apparently, the present invention has highly industrial applicability with nonobviousness to meet criterion of patentability. Accordingly, we submit the patent application for the present invention in accordance with related patent laws.

What is claimed is:

1. A vehicle parking management system with guidance for indicating floor vacant vehicular parking dock comprises a plurality of detectors, a plurality of display units, a servo and a power supply, wherein each said detector, which is securely fixed in each corresponding vehicle parking dock of parking position, includes an optical sensor for functioning to constantly monitor the parking status of its corresponding vehicle parking dock and immediately relaying a signal of such parking status to the servo via a connected cabled network; each said display unit, which is securely fixed in front margin of each corresponding vehicle parking dock, includes a monochromatic illuminator for responding to immediately change the on/off lighting to reflect the parking status of its corresponding vehicle parking dock and sequencing the lighting on/off order as a chasing lights display of Marquee sign in accordance with the command from the servo via a connected cabled network; said servo, which respectively connects to an entrance ticket machine of the parking lot, each detector and each display unit of every vehicle parking dock via a connected cabled network, includes a controlling program for serving to receive, process, store and update all signals of such parking status from detector, then transmit suitable command to each display unit of every vehicle parking dock if any incoming vehicle driver presses the start button on the entrance ticket machine so that each display unit of every vehicle parking dock starts to sequence the lighting on/off order as a chasing lights display of Marquee sign accordingly while the vehicle driver easily follows the planned vehicular circulating route of the parking lot sequential blinks by the chasing lights display of Marquee sign to quickly find the vacant parking dock in the parking lot; and said power supply, which includes an uninterruptible power supply (UPS), provides electrical energy to the detectors, display units and servo.

2. The vehicle parking management system with guidance for indicating floor vacant vehicular parking dock as claimed in claim 1, wherein the signal of such parking status generated and sent out by the optical sensor of the detector is that it is a signal of “occupied parking dock” if sensing a vehicle having parked in the corresponding vehicle parking dock while it is a signal of “vacant parking dock” if sensing no vehicle having parked in the corresponding vehicle parking dock, then simultaneously transmit the signal to the servo for processing, updating and storage.

3. The vehicle parking management system with guidance for indicating floor vacant vehicular parking dock as claimed in claim 1, wherein the optical sensor of the detector is made of anyone of the industrial electronic components such as thermoelectric infrared sensor, quantum infrared sensor, reflection-type active infrared transponder composing of an infrared LED and an infrared receiver, shading-type active infrared sensor composing of an infrared LED and an infrared receiver, as well as passive infrared sensor (PIR).

4. The vehicle parking management system with guidance for indicating floor vacant vehicular parking dock as claimed in claim 2, wherein the optical sensor of the detector is made of anyone of the industrial electronic components such as thermoelectric infrared sensor, quantum infrared sensor, reflection-type active infrared transponder composing of an infrared LED and an infrared receiver, shading-type active infrared sensor composing of an infrared LED and an infrared receiver, as well as passive infrared sensor (PIR).

5. The vehicle parking management system with guidance for indicating floor vacant vehicular parking dock as claimed in claim 1, wherein the display unit includes one illuminator chosen from anyone of following illuminators of different lighting colors such as incandescent lamps or LEDs of various colors like red, blue, green, yellow, white and so on.

6. The vehicle parking management system with guidance for indicating floor vacant vehicular parking dock as claimed in claim 1, wherein the display unit includes at least two illuminators of different lighting colors such that all illuminators function to change the on/off lighting to reflect the parking status of its corresponding vehicle parking dock and sequencing the lighting on/off order as a chasing lights display of Marquee sign in accordance with the command from the servo via a connected cabled network.

7. The vehicle parking management system with guidance for indicating floor vacant vehicular parking dock as claimed in claim 6, wherein the display unit includes two illuminators of different lighting colors chosen from anyone or dual-combination of following illuminators such as incandescent lamps or LEDs of various colors like red, blue, green, yellow, white and so on.
